(19) United States
(12) Patent Application Publication
(10) Pub. No.: US 2004/0136809 A1
(43) Pub. Date: Jul. 15, 2004

(54) Loosening-proof nut

(76) Inventors: Masato Nagawa, Fukuoka (JP); Hideki Noda, Fukuoka (JP)

Correspondence Address: STRAUB & POKOTYLO, 620 TINTON AVENUE, BLDG. B, 2ND FLOOR, TINTON FALLS, NJ, 07724, US

(21) Appl. No.: 10/674,099

(22) Filed: Sep. 29, 2003

(30) Foreign Application Priority Data
Jan. 10, 2003 (JP) 004062/2003

(51) Int. Cl. F16B 37/04

(52) U.S. Cl. 411/183

(57) ABSTRACT

A nut body 11 having a central female thread 12 also has a first and a second slit 13 and 14 formed to partly penetrate the internal female thread from the opposite sides. The distance b between the bottoms of the first and second slits 13 and 14 is in a range of 0.15 to 0.8 times the nominal diameter d. A first and a second push part 15 and 16 which are formed in an upper part of the nut body 11 by the first and second slits 13 and 14 bent downward by plastic deformation.

### BACKGROUND OF THE INVENTION

This application claims benefit of Japanese Patent Application No. 2003-004062 filed on Jan. 10, 2003, the contents of which are incorporated by the reference.

The present invention relates to a loosening-proof nut, which serves to tighten a subject by being screwed on the male thread of a bolt or the like and can also prevent reduction of the tightening force even in case when the subject or bolt experiences external generated vibrations or the like.

A combination of a bolt and a nut is used for tightening various parts of transport means such as vehicles and airplanes, various industrial machines and apparatuses, transport pipelines and electric power transmission facilities. Heretofore, such troubles as loosening of a nut screwed on the male thread of a bolt and resultant detachment of a part due to external vibrations or like forces exerted to as subject tightened by the bolt and nut or the bolt or the like, have not been precluded but occur now and then. For improving the safety of the subject tightening parts, such bolt and nut as to prevent the loosening of nut relative to bolt due to external vibrations or like forces exerted to the subject or the bolt or the like.

As prior art loosening-proof nut to this end, those proposed in Literatures 1 (Japanese patent laid-open No. 2001-32814, see FIG. 1), Literatures 2 (Japanese utility model laid-open No. Showa 60-8514, see FIG. 1), and Literatures 3 (Japanese patent laid-open No. Showa 59-54809, see FIGS. 1-3). The disclosed nut has a slit formed from one side at its vertically intermediate position, and also a nut proposed in Literatures 4 (Japanese patent laid-open No. Hei 11-148509, see FIGS. 1 and 3) , and Literatures 5 (Japanese patent laid-open No. 2002-39143, see FIGS. 1, 2 and 3(b)) has slits formed from the opposite sides at its vertically intermediate position.

The nuts according to the Literatures 1 to 3, which each have a slit formed from the single side, however, pose a problem that a bending load is applied to the bolt due to the fact that the nut body has only a single side slit. Besides, the nuts according to the patent Literatures 1 to 3, each have a slanted tightening surface so as to form a projecting part, in which a slit is formed. Therefore, these nuts also pose problems that their manufacture is somewhat difficult and is difficult in manufacture by using a JIS standard nut. In the nut disclosed in the Literature 4, although the nut has the slits formed from the opposite sides, these sides are in lower parts in the tightening direction. Besides, these lower parts have protuberances. Therefore, the nut dictates considerable cost of manufacture. In the loosening-proof nuts according to the Literatures 1 to 4, the lower part or part formed by the slit or slits are pushingly bent. This means that a sufficient force is required for finally tightening the nut. Besides, a great load is applied to a lower part of the bolt, on which the nut is screwed. Furthermore, the tightening surface is readily subject to scars and scratches due to partial load exerted thereto. Therefore, a washer is required to avoid scars and scratches, which may otherwise formed in the subject. Moreover, no loosening-proof action is obtainable unless the nut is tightened against the subject.

As a further prior art loosening-proof nut, one proposed in FIGS. 1(a) and 1(b) and 2 in Literature 5, has a slit formed from one side and also has a slit formed in the nut body at a vertical center position or a position lower than this position. This nut poses a problem that processing of the nut after the slit formation is difficult and also a problem that the bolt is subject to an eccentric load applied thereto. With an eccentric load applied to the bolt, the bolt may be bent in its use in an extreme state (such as a super-low or super-high temperature state), and sometimes the bolt may be flyingly detached by a single load applied thereto.

### SUMMARY OF THE INVENTION

The present invention was made in view of the above background, and it has an object of providing a loosening-proof nut, which does not apply any eccentric load to the bolt, and is capable of being readily manufactured with good load balance to the bolt.

According to an aspect of the present invention, there is provided a loosening-proof nut comprising a nut body having a central female thread with a nominal diameter d, the nut body also having two or more slits formed such as to be symmetrical with respect to the axis of the nut, radially penetrate the female thread from the outer periphery of the nut and be located at an axial position on the upper side of the axial center position of the nut body, the slits defining push parts, which are bent downward by causing plastic deformation.

In practice, two or three slits are formed, but it is possible to form a greater number of slits as well by making the bottoms of the slits to be circular.

The slits consist of a first and a second slit symmetrical with respect to the axis of the nut, the push parts consist of a first and a second push part defined in an upper part of the nut body by the first and second slit, and the distance b between the bottoms of the first and second slit is in a range of 0.15 to 0.8 times the nominal diameter d. The first and second slits are formed at a position above the vertical center of the nut body. The first and second push parts, which are defined in an upper part of the nut body by the first and second slits, plastically deformed and bent downward.

Thus, substantially more uniform load is applied to the tightening surface, and no irrational eccentric load is applied to the bolt. Since the first and second slits are located in an upper part of the nut body, the tightening of the subject is effected in a lower part of the nut body, and the loosening-proof action is provided in an upper part of the nut body. Thus, only a bolt load which can prevent the loosening of the loosening-proof nut, is applied to the bolt part, on which an upper part of the nut body is screwed. The tightening operation is completed by confirming the projection of the bolt from the upper part of the loosening-proof nut.

The height h of the nut body is at least 0.5 times the nominal diameter d, the bottom width of the first and second slits is 0.05 to 0.2 times the nominal diameter d, the thickness a of the first and second push parts is 0.1 to 0.3 times the nominal diameter d. Thus, it is possible to apply an appropriate loosening-proof load to a bolt upper part, on which the loosening-proof nut is screwed. Furthermore, the process of pushingly bending the first and second push parts defined by the first and second slits can be readily carried out.

The width s of the tip of the first and second push part is in a range of 0 to 0.5 times (preferably, o or a range of 0 to 0.2 times) the bottom width g of the first and second slits. Thus, an adequate loosening-proof action can be provided to the partial female threads formed in the push parts, facilitating the press process on the push parts.

The first and second slits are at an angle between 70 and 90 degrees with respect to the axis of the nut body and are formed substantially symmetrically with respect to the axis of the female screw. In case where the first and second slits are at an angle of 90 degrees with respect to the axis of the nut body, the manufacture can be facilitated very much. In case of a slit angle between 70 and 90 degrees, it is possible to adjust the reaction forces of the first and second push parts by appropriately selecting the angle. The slits which are at an angle between 70 and 90 degrees, may be slanted either upward or downward.

The upper part of the nut body inclusive of the first and second push parts is circular in plan view shape. Thus, the first and second push parts are free from being hooked by any tool such as a spanner, and are not deformed during work. The nut body part which is located below the part which is circular in plan view, usually hexagonal in plan view shape, but it may be quadrangular, octagonal, circular, etc. in pan view shape as well. In the case that the loosening-proof nut according to the present invention, in which the slits are formed symmetrically, the dimensions according to the third to sixth aspects of the present invention are applicable to the height h of the nut body, bottom width g of the slits and the height h of the push parts.

According to another aspect of the present invention, there is provided a nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the direction of the surface, in which the female thread part in the second axial part is formed, is deviated from the axial direction.

According to other aspect of the present invention, there is provided a nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the direction of the surface, in which the female thread part in the second axial part is formed, is deviated from the axial direction by causing plastic deformation of the second axial part.

According to still other aspect of the present invention, there is provided a nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the width of the slit is increased in the axial direction by causing plastic deformation of the second axial part.

According to further aspect of the present invention, there is provided a nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, the female thread parts of the first and second axial parts have the same shape parameter, and the direction of the surface, in which the female thread part in the second axial part is formed, is deviated from the axial direction, and the maximum outer diameter of the second axial part is smaller than the minimum outer diameter of the first axial part.

According to still further aspect of the present invention, there is provided a nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, the second axial part being plastically deformed to increase the width of the slits toward the axis of the nut; and the maximum outer diameter of the second axial part is set to be smaller than the minimum outer diameter of the first axial part.

The outer periphery of the second axial part is circular in shape. The first and second axial part have substantially the same shape. The female thread part formation surface direction of the second axial part is set to be outward from the axis of the nut. As the pair of slits a plurality of slit pairs are formed at predetermined positions uniformly subtending the circumference. The maximum outer diameter of the second axial part is smaller than the minimum outer diameter of the first axial part. The outer periphery of the second axial part is circular in shape.

Other objects and features will be clarified from the following description with reference to attached drawings.

### BRIEF DESCRIPTION OF THE DRAWINGS

FIG. 1 is a sectional view showing an embodiment of the loosening-proof nut according to the present invention;

FIG. 2 is a plan view showing the same loosening-proof nut;

FIG. 3 is a side view showing a method of manufacturing the same loosening-proof nut; and

FIGS. 4(A) and 4(B) are a partial plan view and a sectional view showing a loosening-proof nut showing a second embodiment of the loosening-proof nut according to the present invention;

### PREFERRED EMBODIMENTS OF THE INVENTION

Preferred embodiments of the present invention will now be described with reference to the drawings.

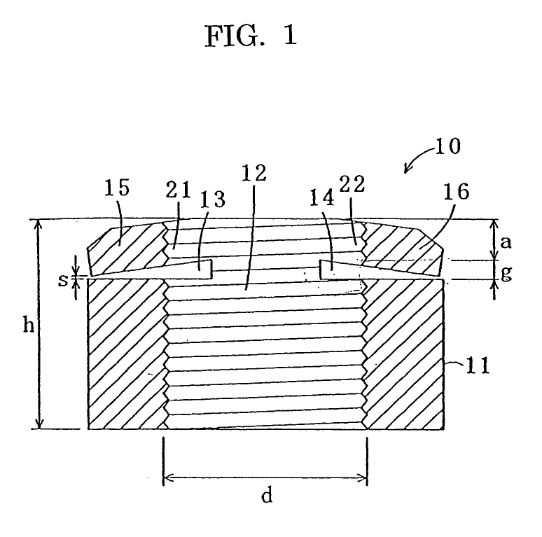

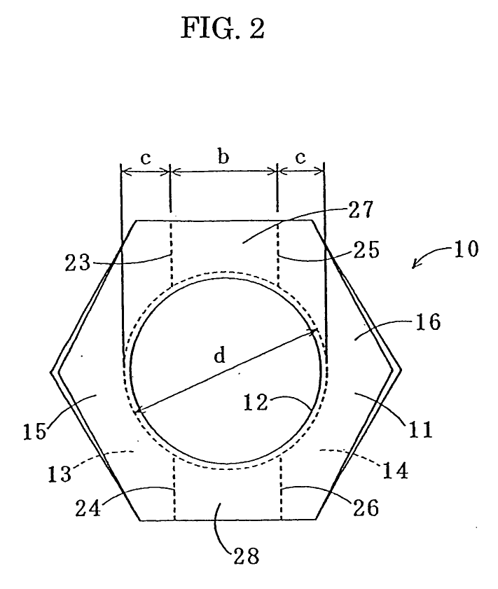

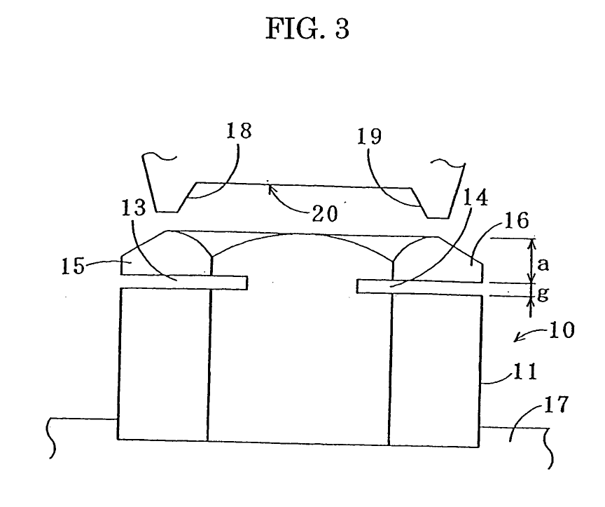

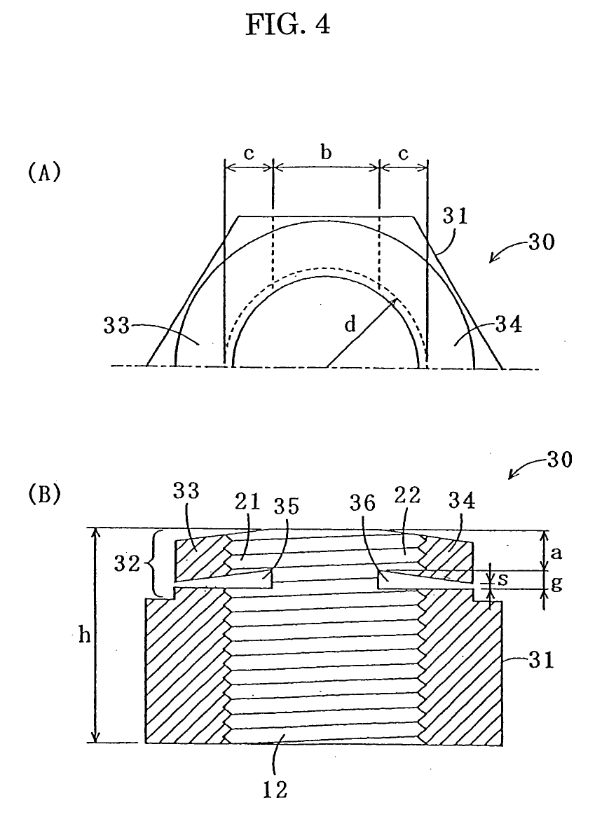

FIG. 1 is a sectional view showing an embodiment of the loosening-proof nut according to the present invention, FIG. 2 is a plan view showing the same loosening-proof nut, FIG. 3 is a side view showing a method of manufacturing the same loosening-proof nut, and FIGS. 4(A) and 4(B) are a partial plan view and a sectional view showing a loosening-proof nut showing a second embodiment of the loosening-proof nut according to the present invention.

As shown in FIG. 1, the first embodiment of the loosening-proof nut 10 according to the present invention comprises a nut body 11 with a central female thread 12 having a nominal diameter d. The term “nominal diameter” is used for representing the nut size in JIS or like standards, and is substantially identical with the valley bottom diameter of the female thread 12. The height h of the nut body 11 is more than 0.5 times, i.e., about 0.75 to 1.1 times, the nominal diameter d. With this height h, the loosening-proof nut 10 provides a sufficient tightening force. The female thread 12 may be of various pitch sizes, such as thick, medium and thin, and the present invention is applicable to any pitch size. When the height h of the loosening-proof nut 10 is small, i.e., smaller than the above range, the loosening-proof nut 10 is impractical due to low values of the tightening load and the above loosening-proof load. The height h of the loosening-proof nut 10, on the other hand, maybe increased since the performance is not affected, although space problems may be encountered.

The opposite sides of the nut body 11 are formed with a first and a second diametrically symmetrical slit 13 and 14, thus forming a first and a second corresponding push part (or loosening-proof part) 15 and 16 of the nut body 11. The first and second slits 13 and 14 have to be formed in parts of the female thread 12. In this embodiment, the first and second slits 13 and 14 are formed symmetrically with respect to and at right angles (90 degrees) to the axis of the female thread 12. The first and second slits 13 and 14 may also be formed to be at an angle between 70 and 90 degrees to the axis of the female screw 2. While in this embodiment the nut body 11 is formed on the opposite sides thereof with two slits 13 and 14 on the opposite side, it is also possible to form three 120 degrees spaced-apart slits reaching the inner female thread 12.

As shown in FIGS. 1 and 2, the distance b between the bottoms of the first and second slits 13 and 14 is 0.15 to 0.8 times (preferably 0.3 to 0.7 times) the nominal diameter d. The bottom width of the first and second slits is 0.05 to 0.2 times the nominal diameter d (preferably, 0.08 to 0.15 times). The thickness a of the first and second push parts, which are formed in an upper part of the nut body 11 by the first and second slits 13 and 14, is 0.1 to 0.3 times (preferably 0.15 to 0.25 times) the nominal diameter d.

The tip width (or clearance) is of the first and second push parts 15 and 16 is in a range of 0 to 0.5 times (preferably less than 0.3 times) the bottom width of the first and second slits 13 and 14. Under these dimensional conditions, the first and second push parts 15 and 16 can be readily formed by bending. Specifically, for the bending formation, as shown in FIG. 3, the nut body 11 with the first and second slits 13 and 14 formed therein is set on a die 17, and its part defined by the first and second slits 13 and 14 are pushed down with a ponch 20 having symmetrical downward protuberances 18 and 19. At this time, the parts defined by the first and second slits 13 and 14 are pushed down until their tips are brought into contact with the bottom surfaces of the first and second sits 13 and 14. By so doing, the push parts undergo plastic deformation to become the first and second push parts 15 and 16. Depending on the use, the tip width s is increased due to plastic deformation.

Since the first and second slits 13 and 14 extend into the female thread 12, as shown in FIG. 1, the first and second push parts 15 and 16 shown in FIG. 2 are bent downward from their parts corresponding to the bottom of the first and second slits 13 and 14. The first and second push parts 15 and 16 are formed with partial female threads 21 and 22, which are continuous with the female thread of the nut body 11 but are bent downward from their central part. Thus, when screwing a bolt through the loosening-proof nut 10, a load is provided such that the partial female threads 21 and 22 pushes the thread hills of the bolt downward. When tightening a subject, on the other hand, a load is produced such that the female thread 12 pushes the thread hills of the bolt upward. Thus, although the tightening force exerted to the subject is provided by the female thread 12 exclusive of the partial female threads 21 and 22, a sufficient tightening force is obtainable owing to the first and second slits 13 and 14 provided in an upper part of the nut body 11.

For the above reason, the distance b between the bottoms of the first and second slits 13 and 14 is set to 0.15 to 0.8 times (preferably 0.3 to 0.7 times) the nominal diameter d. When the distance b is larger than this range, no region for the formation of the partial threads 21 and 22 is provided. When the distance d is smaller than this range, on the other hand, the mechanical strength of parts 27 and 28 between the bottoms of the first ad second slits 13 and 14 is reduced. Thus, it is necessary to set the repulsive force F1 of the partial female threads 21 and 22 when the bolt is screwed through the loosening-proof nut 10 to be less than a mechanical strength F2 not exceeding the elastic limit of the parts 27 and 28.

The bottom width (or bottom height) g of the first and second slits 13 and 14 is set to be 0.05 to 0.2 ties (preferably 0.08 to 0.15 times) the nominal diameter d. This is so because when the bottom width g is less than the nominal diameter d, no bending margin of the first and second push parts 15 and 16 is provided. When the bottom with g exceeds 0.2 times, on the other hand, the first and second push parts 15 and 16 are excessively bent, and also the regions of the partial female threads 21 and 22 and the female thread 12 are reduced.

Also, the thickness a of the first and second push parts 15 and 16 is set to be 0.1 to 0.3 times (preferably 0.15 to 0.25 times) the nominal diameter d. This is so because when the thickness a of the first and second push parts 15 and 16 is less than this range, it is impossible to produce a sufficient loosening-proof load. When the thickness a exceeds the range, on the other hand, an excessive loosening-proof load is produced. Further, the necessary height of the loosening-proof nut is increased, which is undesired from the standpoint of economy. Labeled c in FIG. 2 is the depth of cut with respect to the female screw 12.

When the bolt is screwed through the loosening-proof nut 10, the downwardly bent first and second push parts 15 and 16 are raised. Thus, the maximum load is produced in the stem parts 23 to 26 of the first and second push parts 15 and 16. Thus, the loosening-proof nut 10 can be used repeatedly so long in a range that these parts do not undergo plastic deformation. The load for providing the loosening-proof action with respect to the bolt, is produced in the part, in which the loosening-proof threads 21 and 22 are screwed through the bolt. In this embodiment of the loosening-proof nut 10, when a predetermined bolt is screwed through the loosening-proof nut 10 in the state that the tips of the first and second push parts 15 and 16 of the nut 10 are pushed down (that is, with slit width s of zero or nearly zero), for the first time the first and second push parts 15 and 16 are raised with plastic deformation, and in the state that the screwed state of the bolt is released, the first and second push parts 15 and 16 are slightly raised to increase the slit width s. For the second and further times, however, the first and second push parts 15 and 16 undergo plastic deformation, and thus the loosening-proof nut 10 can be used repeatedly. The screwing of the bolt through the loosening-proof nut 10 requires a predetermined preparing torque.

This load (i.e., loosening-proof load) depends on the broadness and bending extent of the partial female threads 21 and 22 screwed on the male thread. Also, it is sufficient that the height of the loosening-roof nut 10 and the dimensions of the first and second slits 13 and 14 and the first and second push part 15 and 16 satisfy the above dimensions and that the area S1 of the partial female threads 21 and 22 is 0.04 to 0.3 times (preferably 0.08 to 0.25 times) the substantial female thread area (π dh) of the loosening-proof nut 10. When the area S1 of the partial female threads 21 and 22 is smaller than this range, the loosening-proof load is reduced. When the area S1 is larger than the range, on the other hand, the tightening force of the loosening-proof nut itself is insufficient. The above dimensions and areas are also applied to a second embodiment of the loosening-proof unit 30 according to the present invention to be described hereinunder.

FIGS. 4(A) and 4(B) show a second embodiment of loosening-proof nut 30 according to the present invention, which will now be described. This nut 30 is different from the loosening-proof nut 10 described above in that an upper part 32 of the nut body 31 is circular in plan view shape. The upper part 32 includes the periphery of the first and second push parts 33 and 34, and in this embodiment it also includes lower parts of the first and second slits 35 and 36. Thus, when it is intended to turn the loosening-proof nut 30 with such tool as a spanner or a monkey wrench, the first and second pushed parts 33 and 34 are not hooked by such tool, and it is thus possible to prevent accidental breakage. For the remaining parts, the loosening-proof nut 30 is the same as the loosening-proof nut 10, and are hence not described while providing like reference numerals.

The above embodiments have concerned with the cases of applying the present invention to hexagon nuts as the loosening-proof nuts 10 and 30, but it is also possible to apply the present invention to other shape nuts (such as butterfly nuts and blind nuts.

Also, while the above embodiments have been described with limited numerical values, it is possible to change the numerical values without changing the subject matter of the present invention.

In the above first and second embodiments of the loosening-proof nuts 10 and 30, the surface to be in contact with the subject (i.e., the bottom surface of each of the nut bodies 11 or 31) is formed as a surface normal to the axis of each of the nut bodies 11 and 31.

According to the embodiments of the present invention the following remarkable advantages are obtainable.

(1) Since the nut body has the slits formed symmetrically with respect to its axis such as to reach the female thread, no eccentric load is applied to the bolt. Also, the female thread in a lower part of the nut body has an action of tightening the subject, the partial female threads formed in push parts in the upper part of the nut body provide a loosening-proof load to the bolt, and these actions are in opposite directions. Thus, no such great load as applied when the two actions are otherwise both applied to the bolt is generated. It is thus possible to enhance the mechanical strength of the bolt itself even in such extreme state as super-low or super-high temperature state.

(2) Since the bottom of the nut body does not need any protuberance or inclined surface, it is possible to evenly apply load to the subject, and the screwing can be made without use of any washer or the like.

(3) Since the push parts having the partial female threads are found in the upper part of the nut body, the tightened state of the nut can be confirmed by confirming the projection of the bolt from the upper end of the loosening-proof nut. Thus, compared to the prior art nut body which has slits in its lower part, the secured state can be readily confirmed.

Specifically, the loosening-proof nut in which the slits consist of a first and a second slit symmetrical with respect to the axis of the nut, the push parts consist of a first and a second push part defined in an upper part of the nut body by the first and second slit, and the distance b between the bottoms of the first and second slit is in a range of 0.15 to 0.8 times the nominal diameter d is easy to be manufactured.

According to the loosening-proof in which the height h of the nut body is at least 0.5 times the nominal diameter d, the bottom width of the first and second slits is 0.05 to 0.2 times the nominal diameter d, the thickness a of the first and second push parts is 0.1 to 0.3 times the nominal diameter d, it is possible to apply an adequate load, i.e., a loosening-proof load which prevents loosening under the usual condition of vibrations, to an upper part of the bolt screwed in the loosening-proof nut. Also, it is possible to readily carry out the process of pushingly bending the first and second push parts defined by the first and second slits.

The loosening-proof nut has a structure in which the width s of the tip of the first and second push part is in a range of 0 to 0.5 times the bottom width g of the first and second slits. Thus, the press process for the push parts can be readily carried out by applying an adequate loosening-proof force to the partial female threads formed in the push parts. Particularly, in case where the width s at the tip of the first and second push parts is preset to zero or nearly zero with respect to the bottom width g of the first and second slits, the first and second push parts can be readily pushingly bent in the press process.

The loosening-proof nut has structure in which the first and second slits are at an angle between 70 and 90 degrees with respect to the axis of the nut body and are formed substantially symmetrically with respect to the axis of the female screw. In the case where the first and second slit are at an angle of 90 degrees with respect to the nut body axis, the manufacture can be extremely facilitated. In the case where the slit angle is between 70 and 90 degrees, it is possible to adjust the degree of the push bending of the first and second push parts and provide a best loosening-proof nut.

The loosening-proof nut has a structure in which the upper part of the nut body inclusive of the first and second push parts is circular in plan view shape. Thus, the first and second push parts are free from being hooked by any tool such as a spanner, and are not deformed during work.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A loosening-proof nut comprising a nut body having a central female thread with a nominal diameter d, the nut body also having two or more slits formed such as to be symmetrical with respect to the axis of the nut, radially penetrate the female thread from the outer periphery of the nut and be located at an axial position on the upper side of the axial center position of the nut body, the slits defining push parts, which are bent downward by causing plastic deformation.

2. The loosening-proof nut according to claim 1, wherein the slits consist of a first and a second slit symmetrical with respect to the axis of the nut, the push parts consist of a first and a second push part defined in an upper part of the nut body by the first and second slit, and the distance b between the bottoms of the first and second slit is in a range of 0.15 to 0.8 times the nominal diameter d.

3. The loosening-proof nut according to claim 2, wherein the height h of the nut body is at least 0.5 times the nominal diameter d, the bottom width of the first and second slits is 0.05 to 0.2 times the nominal diameter d, the thickness a of the first and second push parts is 0.1 to 0.3 times the nominal diameter d.

4. The loosening-proof nut according to claim 2 or 3, wherein the width s of the tip of the first and second push part is in a range of 0 to 0.5 times the bottom width g of the first and second slits.

5. The loosening-proof nut according to one of claims 2 to 4, wherein the first and second slits are at an angle between 70 and 90 degrees with respect to the axis of the nut body and are formed substantially symmetrically with respect to the axis of the female screw.

6. The loosening-proof nut according to one of claims 2 to 6, wherein the upper part of the nut body inclusive of the first and second push parts is circular in plan view shape.

7. A nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the direction of the surface, in which the female thread part in the second axial part is formed, is deviated from the axial direction.

8. A nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the direction of the surface, in which the female thread part in the second axial part is formed, is deviated from the axial direction by causing plastic deformation of the second axial part.

9. A nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, and the width of the slit is increased in the axial direction by causing plastic deformation of the second axial part.

10. A nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, the female thread parts of the first and second axial parts have the same shape parameter, and the direction of the surface, in which the female thread part in the second axial part is formed, is deviated from the axial direction, and the maximum outer diameter of the second axial part is smaller than the minimum outer diameter of the first axial part.

11. A nut having an internal female thread, a first opening from which a male thread to be screwed is inserted, and a second opening, from which the inserted male thread gets out; wherein the nut comprises at least a pair of slits formed at an axial position closer to the second opening and such as to be symmetrical with respect to the axis of the nut and to radially partly penetrate the female thread from the outer periphery of the nut, a first axial part defined on the first opening side and a second axial part defined on the second opening side bounded by the pair of slits, and the female thread parts of the first and second axial parts have the same shape parameter, the second axial part being plastically deformed to increase the width of the slits toward the axis of the nut; and the maximum outer diameter of the second axial part is set to be smaller than the minimum outer diameter of the first axial part.

12. The nut according to one of claims 7 to 11, wherein the outer periphery of the second axial part is circular in shape.

13. The nut according to one of claims 7 to 11, wherein the first and second axial part have substantially the same shape.

14. The nut according to one of claims 7 to 11, wherein the female thread part formation surface direction of the second axial part is set to be outward from the axis of the nut.

15. The nut according to one of claims 7 to 11, wherein as the pair of slits a plurality of slit pairs are formed at predetermined positions uniformly subtending the circumference.

16. The nut according to one of claims 7 to 11, wherein the maximum outer diameter of the second axial part is smaller than the minimum outer diameter of the first axial part.

17. The nut according to one of claims 7 to 11, wherein the outer periphery of the second axial part is circular in shape.
